(19) United States
(12) Patent Application Publication
(10) Pub. No.: US 2011/0072143 A1
(43) Pub. Date: Mar. 24, 2011

(54) SCHEDULING METHOD FOR PEER-TO-PEER DATA TRANSMISSION AND NODE AND SYSTEM USING THE SAME

(75) Inventors: Lun-Chia Kuo, Taichung City (TW); Chung-Wei Lin, Changhua County (TW); Tzu-Ming Weng, Kaohsiung City (TW)

(73) Assignee: INDUSTRIAL TECHNOLOGY RESEARCH INSTITUTE, Hsinchu (TW)

(21) Appl. No.: 12/795,630

(22) Filed: Jun. 7, 2010

Related U.S. Application Data
(60) Provisional application No. 61/243,537, filed on Sep. 18, 2009.

(30) Foreign Application Priority Data
Jan. 5, 2010 (TW) 99100078

(51) Int. Cl. G06F 15/16

(52) U.S. Cl. 709/230

(57) ABSTRACT

A scheduling method for peer-to-peer data transmission suitable for a peer-to-peer system is described. The peer-to-peer system comprises a plurality of nodes, and the nodes comprise an i^{th} and j^{th} nodes, wherein the j^{th} node uploads a plurality of upload files to the nodes connected thereto, and the upload files comprise an upload file Fᵢⱼ. The scheduling method determines a distributed upload bandwidth Uᵢⱼ of the upload file Fᵢⱼ according to at least one of a plurality of file sizes of the upload files and at least one of the time differences between a plurality of playback deadlines of the upload files and a current transmission time.

This application claims the priority benefit of U.S. provisional application Ser. No. 61/243,537, filed on Sep. 18, 2009 and Taiwan application serial no. 99100078, filed Jan. 5, 2010. The entirety of each of the above-mentioned patent applications is hereby incorporated by reference herein and made a part of specification.

### BACKGROUND

1. Technical Field

The present disclosure generally relates to a peer-to-peer system, and more particularly to a scheduling method for peer-to-peer data transmission, the node and system using the scheduling method.

2. Relative Prior Art

The conventional multimedia video pushing system adopts the client-server network architecture. When the client node connected to the conventional multimedia video pushing system needs to download the video data, the client node downloads the file from the server node. Unfortunately, when the conventional multimedia video pushing system is massive, and the download file having a large file size is downloaded by many client nodes at the same time, the congestion and the problem of insufficient bandwidth occur.

In the foregoing case, the client nodes may not obtain the video data before the predetermined display time, and therefore the download file may be not complete during the predetermined display time. That is, the client node may obtain the video data having the expired information. For example, the video has the promotion information for products on Apr. 1, 2009 and the predetermined display time is from March 30 to Mar. 31, 2009. Due to the congestion and the problem of insufficient bandwidth, the client node may obtain the video data after Apr. 1, 2009.

Regarding the advertisement video pushing system, the advertisement enterprise may push the video via the internet to the advertisement display apparatuses everywhere. Although the bandwidth grows with each passing day, the video data also grows with each passing day, so as to meet the demand of the full high definition (full HD) or full HD 3D video. The bit rate of the full HD video data is about 25-30 Mega-bits per second (Mbps), and the file size of the full HD 3D video with 20 minutes even reaches 30 Giga-bits. Accordingly, under the client-server network architecture, the advertisement enterprise must lend a reserved line (such as a T3 line) to try to guarantee the upload bandwidth of the server node. However, the cost of the reserved line is expensive, and even regardless of the cost, sometimes the video may be obtained by the client node after the playback deadline of the video.

Recently, the peer-to-peer software makes the nodes connected to the network share the file with each other for improving the problem of insufficient bandwidth.

### SUMMARY

An exemplary example of the present disclosure provides a scheduling method for peer-to-peer data transmission, used in a peer-to-peer system. The peer-to-peer system comprises a plurality of nodes, the nodes comprises an i^{th} node and a j^{th} node, wherein the j^{th} node uploads a plurality of upload files to the nodes connected thereto, and the upload files comprises an upload file Fᵢⱼ uploaded to the i^{th} node. A distributed upload bandwidth Uᵢⱼ of the upload file Fᵢⱼ is determined according to at least one of time differences between a current transmission time and at least one of playback deadlines of the upload files and at least one of file sizes of the upload files.

An exemplary example of the present disclosure provides a scheduling method for peer-to-peer data transmission, used in a peer-to-peer system. The peer-to-peer system comprises a plurality of nodes, the nodes comprises an i^{th} node and a j^{th} node, wherein the i^{th} node downloads a plurality of download files to the nodes connected thereto, and the download files comprises an download file Fᵢⱼ downloaded from the j^{th} node. A distributed download bandwidth Dᵢⱼ of the download file Fᵢⱼ is determined according to at least one of time differences between a current transmission time and at least one of playback deadlines of the download files and at least one of file sizes of the download files.

An exemplary example of the present disclosure provides a scheduling method for peer-to-peer data transmission, used in a peer-to-peer system. The peer-to-peer system comprises a plurality of nodes, and the nodes comprises an i^{th} node and a j^{th} node, wherein the i^{th} node uploads a plurality of upload files to the nodes connected thereto, the i^{th} node downloads a plurality of download files to the nodes connected thereto. The upload files comprises an upload file Fᵢⱼ uploaded to the i^{th} node, and the download files comprises an download file Fᵢⱼ downloaded from the j^{th} node. The upload file Fᵢⱼ is the download file Fᵢⱼ. A distributed upload bandwidth Uᵢⱼ of the upload file Fᵢⱼ is determined according to at least one of time differences between a current transmission time and at least one of playback deadlines of the upload files and at least one of file sizes of the upload files. A distributed download bandwidth Dᵢⱼ of the download file Fᵢⱼ is determined according to at least one of time differences between a current transmission time and at least one of playback deadlines of the download files and at least one of file sizes of the download files. An upload bandwidth for uploading the upload file Fᵢⱼ from the j^{th} node to the i^{th} node is allocated according to a minimum of the distributed upload bandwidth Uᵢⱼ of the upload file Fᵢⱼ and the distributed upload bandwidth Uᵢⱼ of the upload file Fᵢⱼ.

An exemplary example of the present disclosure provides an upload node for peer-to-peer data transmission, used in a peer-to-peer system. The peer-to-peer system comprises a plurality of nodes, the nodes comprises an i^{th} node, wherein the upload node uploads a plurality of upload files to the nodes connected thereto, and the upload files comprises an upload file Fᵢ uploaded to the i^{th} node. The upload node determines a distributed upload bandwidth Uᵢ of the upload file Fᵢ according to at least one of time differences between a current transmission time and at least one of playback deadlines of the upload files and at least one of file sizes of the upload files.

An exemplary example of the present disclosure provides a download node for peer-to-peer data transmission, used in a peer-to-peer system. The peer-to-peer system comprises a plurality of nodes, the nodes comprises a j^{th} node, wherein the download node downloads a plurality of download files to the nodes connected thereto, and the download files comprises an download file Fⱼ downloaded from the j^{th} node. The download node determines a distributed download bandwidth Dⱼ of the download file Fⱼ according to at least one of time differences between a current transmission time and at least one of playback deadlines of the download files and at least one of file sizes of the download files.

An exemplary example of the present disclosure provides a peer-to-peer system. The peer-to-peer system comprises a plurality of nodes, the nodes comprises an i^{th} node and a j^{th} node, wherein the j^{th} node uploads a plurality of upload files to the nodes connected thereto, and the i^{th} node downloads a plurality of download files to the nodes connected thereto. The upload files comprises an upload file Fᵢⱼ uploaded to the i^{th} node, and the download files comprises an download file Fᵢⱼ downloaded from the j^{th} node. The upload file Fᵢⱼ is the download file Fᵢⱼ. A distributed upload bandwidth Uᵢⱼ of the upload file Fᵢⱼ is determined according to at least one of time differences between a current transmission time and at least one of playback deadlines of the upload files and at least one of file sizes of the upload files. A distributed download bandwidth Dᵢⱼ of the download file Fᵢⱼ is determined according to at least one of time differences between a current transmission time and at least one of playback deadlines of the download files and at least one of file sizes of the download files. An upload bandwidth for uploading the upload file Fᵢⱼ from the j^{th} node to the i^{th} node is allocated according to a minimum of the distributed upload bandwidth Uᵢⱼ of the upload file Fᵢⱼ and the distributed upload bandwidth Uᵢⱼ of the upload file Fᵢⱼ.

Accordingly, the scheduling method for peer-to-peer data transmission, the node and system using the scheduling method of the present disclosure are illustrated above. The scheduling method for peer-to-peer data transmission improves the problem of the congestion in the network, makes the nodes efficiently share the files, and avoids the case that the node obtains the file after the playback deadline of the file. That is, the scheduling method for peer-to-peer data transmission might guarantees the nodes obtains the file before the playback deadline of the file.

It is to be understood that both the foregoing general description and the following detailed description are exemplary, and are intended to provide further explanation of the disclosure as claimed.

### BRIEF DESCRIPTION OF THE DRAWINGS

The accompanying drawings are included to provide a further understanding of the present disclosure, and are incorporated in and constitute a part of this specification. The drawings illustrate exemplary examples of the disclosure and, together with the description, serve to explain the principles of the present disclosure.

FIG. 1 is a schematic chart showing the time points of the current transmission time and playback deadlines of two files according to an exemplary example of the present disclosure.

FIG. 2 is a schematic diagram showing a peer-to-peer data transmission system according to an exemplary example of the present disclosure.

FIG. 3 is a table showing the content of the playlist according to an exemplary example of the present disclosure.

FIG. 4 is a table showing the group list according to an exemplary example of the present disclosure.

FIG. 5 is a table showing the buffer map of file according to an exemplary example of the present disclosure.

FIG. 6 is a table showing the requests of the user nodes 203, 204, and 208 according to an exemplary example of the present disclosure.

FIG. 7 is a curve diagram showing the playback deadline left versus the priority of the file according to an exemplary example of the present disclosure.

FIG. 8 is a flow chart showing a scheduling method for peer-to-peer data transmission according to one exemplary example.

FIG. 9 is a flow chart showing a scheduling method for peer-to-peer data transmission according to one exemplary example.

FIG. 10 is a flow chart showing a scheduling method for peer-to-peer data transmission according to one exemplary example.

### DESCRIPTION OF THE EMBODIMENTS

Reference will now be made in detail to the exemplary examples of the present disclosure which are illustrated in the accompanying drawings. Wherever possible, the same reference numbers are used in the drawings and the description to refer to the same or like parts.

Regarding the application for downloading the file in the peer-to-peer system, a node may receive multiple download files and transmit multiple upload files. The download files received by the node have the different playback deadlines thereof, and therefore the priorities may be assigned to download files according to the playback deadlines of the download files. In the similar manner, the upload files received by the node have the different playback deadlines thereof, and therefore the priorities may be assigned to upload files according to the playback deadlines of the upload files. The present disclosure considers the playback deadline and other factors to make transmission more efficient.

The scheduling method according to one exemplary example of the present disclosure considers at least one of time differences between a current transmission time and at least one of playback deadlines of multiple download files downloaded by an i^{th} node and at least one of file sizes of the download files download by the i^{th} node to determine the distributed download bandwidth Dᵢⱼ of the download file Fᵢⱼ downloaded from the j^{th} node to the i^{th} node.

Furthermore, the scheduling method considers at least one of time differences between a current transmission time and at least one of playback deadlines of multiple upload files uploaded by a j^{th} node and at least one of file sizes of the upload files uploaded by the j^{th} node to determine the distributed upload bandwidth Uᵢⱼ of the upload file Fᵢⱼ uploaded from the j^{th} node to the i^{th} node. Then the scheduling method allocates an upload bandwidth according to the minimum of the distributed download bandwidth Dᵢⱼ and the distributed upload bandwidth Uᵢⱼ to the j^{th} node for uploading the upload file Fᵢⱼ to the i^{th} node.

As illustrated above, when determining the distributed download bandwidth of the download file, at least one of time differences between a current transmission time and at least one of playback deadlines of multiple download files downloaded by an i^{th} node, and at least one of file sizes of the download files download by the i^{th} node are considered. When determining the distributed upload bandwidth of the upload file, at least one of time differences between a current transmission time and at least one of playback deadlines of multiple upload files uploaded by a j^{th} node, and at least one of file sizes of the upload files uploaded by the j^{th} node are also considered.

For example, the distributed download bandwidth of the file Fᵢⱼ downloaded to the i^{th} node from the j^{th} node can be determined according to the products of the file sizes multiplying the time differences, wherein the time differences are the time differences between a current transmission time and the playback deadlines of multiple download files downloaded by the i^{th} node, and the file sizes are the file sizes of the download files download by the i^{th} node. In the similar manner, the distributed upload bandwidth of the file Fᵢⱼ uploaded from the j^{th} node to the i^{th} node can be determined according to the products of the file sizes multiplying the time differences, wherein the time differences are the time differences between a current transmission time and the playback deadlines of multiple upload files uploaded by the j^{th} node, and the file sizes are the file sizes of the upload files uploaded by the j^{th} node.

However, to explain briefly the present disclosure, in the next following exemplary example, when determining the distributed download bandwidth of the download file, multiple time differences between a current transmission time and multiple playback deadlines of multiple download files downloaded by an i^{th} node, and multiple file sizes of the download files download by the i^{th} node are considered. When determining the distributed upload bandwidth of the upload file, multiple time differences between a current transmission time and multiple playback deadlines of multiple upload files uploaded by a j^{th} node, and multiple file sizes of the upload files uploaded by the j^{th} node are also considered.

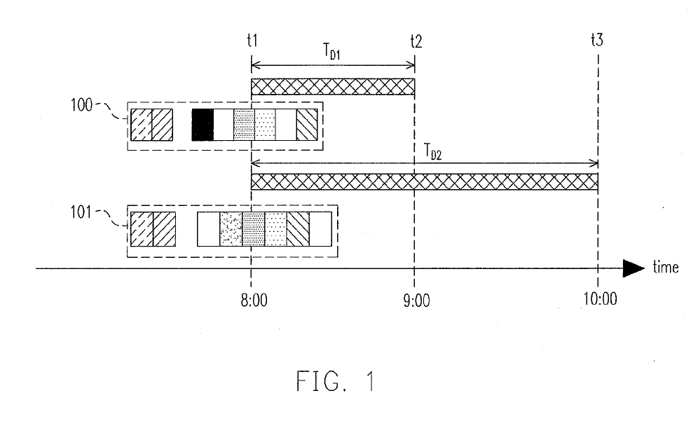

Referring to FIG. 1, FIG. 1 is a schematic chart showing the time points of the current transmission time and playback deadlines of two files according to an exemplary example of the present disclosure. In FIG. 1, the node receives two files 100 and 101, wherein a playback deadline t2 of the file 100 is 9:00, a playback deadline t3 of the file 101 is 10:00, and a current transmission time is 8:00. The file 100 should be received by the node before the playback deadline t2, and the file 101 should be received by the node before the playback deadline t3. Since the time difference T_{D1} between the current transmission time t1 and the playback deadline t2 is less than the time difference T_{D2} between the current transmission time t1 and the playback deadline t3, the priority for transmitting the file 100 to the node should be higher than the priority for transmitting the file 101 to the node, and the transmission bandwidths of the files 100 and 101 should be reasonably allocated according to the priorities for transmitting the files 100 and 101 to the node.

The scheme illustrated in FIG. 1 may be seen in the multimedia video pushing system. Due the demand of full HD video, the bit rate is ultra high, and after the file has been downloaded to the node (i.e. the multimedia video display), the multimedia video display stores the file into the storage place and displays the files stored in the storage place by turns. The peer-to-peer nodes and the advertisement provider can not accept that the frames are displayed discontinuous, and the demand to avoid obtaining the uncompleted file and occupying the bandwidth repeatedly are solicited. Therefore, the most multimedia video pushing systems use the file download mode rather than the streaming mode.

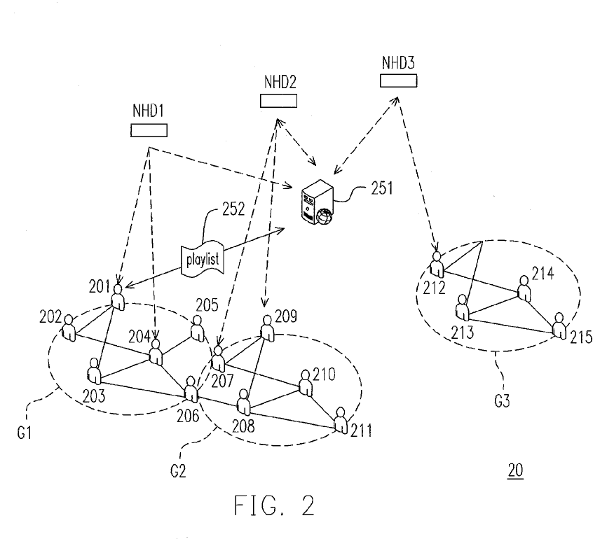

The multimedia video pushing system is a peer-to-peer data transmission system. Referring to FIG. 2, FIG. 2 is a schematic diagram showing a peer-to-peer data transmission system according to an exemplary example of the present disclosure. The peer-to-peer data transmission system 20 comprises a primary source node 251, a plurality of user nodes 201-215, and a plurality of network hard disks NHD1-NHD3. The network hard disks NHD1-NHD3 are connected to the user nodes 201, 204, 207, 209, 212, and the primary source node 251. The user nodes 201-215 in the peer-to-peer data transmission system 20 can share the files with each other, and that is each the user nodes may act as the upload node and the download node, for uploading files to the nodes connected thereto and downloading the files from the nodes connected thereto. Furthermore, the user nodes having the same segments of the file can be grouped into a group. For example, the user nodes 201-207 form a group G1, the user nodes 206-211 form a group G2, and the user nodes 212-215 form a group G3.

The primary source node 251 is used to provide the primary files. Generally speaking, the peer-to-peer data transmission system 20 may comprise more than one primary source node, and the number of the primary source node is not used to limit the present disclosure. The files from the primary source node 251 may be provided by the content provider, or the files from the primary source node 251 may be the video files which the primary source node 251 wants to distribute to the user nodes, for example the personal radio station. The files distributed by the primary source node 251 can be stored into the network hard disks NHD1-NHD3. Each of the user nodes, for example the user node 201, may login the primary source node 251 to obtain a playlist 252, or the primary source node 251 can actively distribute the playlist 252 to the user node 201. For example, the user node may obtain the playlist 252 distributed by the primary source node 251 via ordering the Really Simple Syndication (RSS).

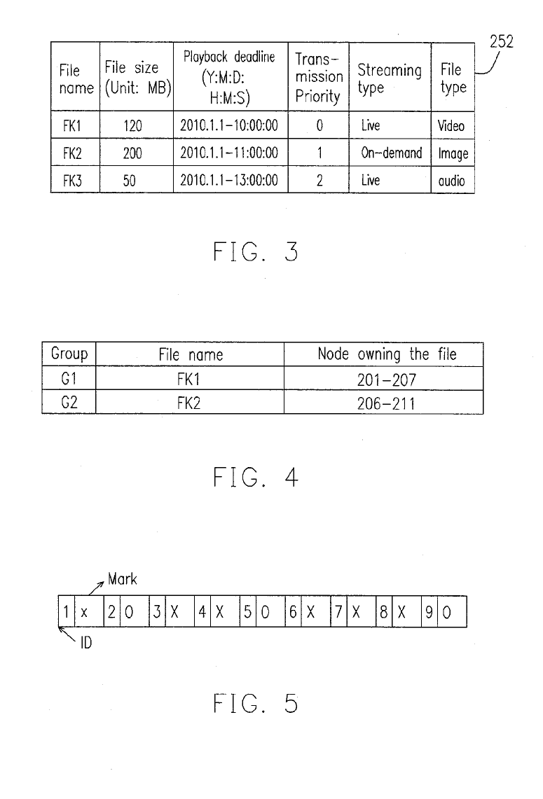

The playlist 252 can be edited by the user node 201 or by an administrator of whole P2P system. The content of the playlist 252 is illustrated in FIG. 3. Referring to FIG. 3, FIG. 3 is a table showing the content of the playlist according to an exemplary example of the present disclosure. The playlist 252 comprises multiple file names, multiple file sizes, playback deadlines, priorities, streaming types, and file types of the download files of the user node 201. As mentioned above, the user node 201 or the administrator of the user node 201 can edit the playlist, such as amending the playback deadlines or the others.

The download file FK1 has a file size of 120 Mega-Bytes (MBs), a playback deadline of 2010.1.1-10:00:00 (Year:Month:Day:Hour:Minute:Second), a transmission priority of 0, a streaming type of Live, and a file type of Video. The download file FK2 has a file size of 200 MBs, a playback deadline of 2010.1.1-11:00:00, a transmission priority of 1, a streaming type of On-demand, and a file type of Image. The download file FK3 has a file size of 50 MBs, a playback deadline of 2010.1.1-13:10:00, a transmission priority of 2, a streaming type of Live, and a file type of audio. Kinds of the file type further comprise a text type, a music type, and all current possible file types.

The user nodes having the same segments of the file can be grouped into a group, and distributor center receives the playlists of the user nodes in the same group to export a group playlist (not shown in figures of the present disclosure), wherein the user nodes can be the client nodes and the server nodes, the distributor center can be at least one client node, at least one server node, or both the client and server nodes, and the administrator and distributor center may be the same node or not. The process that the user nodes having the same segments of the file are be grouped into a group is called peer-selection. Referring to FIG. 4, FIG. 4 is a table showing the group list according to an exemplary example of the present disclosure. In the exemplary example, the user nodes 201-207 having the at least one segment of the file FK1 form a group G1, and the user nodes 206-211 having the at least one segment of the file FK2 form a group G2.

Further referring to FIG. 5, FIG. 5 is a table showing the buffer map of the file according to an exemplary example of the present disclosure. The buffer map of the file, for example the file FK1, shows statuses of the segments of the file in the user node, wherein the ID means the segment identification number, the mark “O” means the corresponding segment has been downloaded, and the mark “X” means the corresponding segment has not been downloaded. In FIG. 5, the second, fifth, and ninth segments of the file have been downloaded, and the other segments have not been downloaded. The buffer map is in the user node, the distributor center or the administrator, and is updated every a period ψ, to try to guarantee the correctness and immediateness of the information in the buffer map.

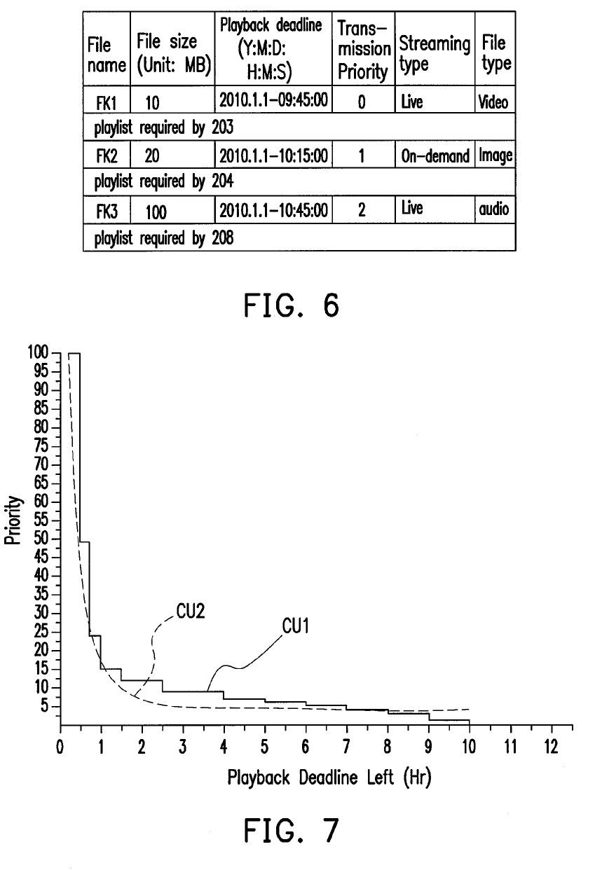

Referring to FIG. 6, FIG. 6 is a table showing the requests of the user nodes 203, 204, and 208. In the exemplary example, the user node 203 request the user node 206 to transmit file FK1 to itself, the user node 204 request the user node 206 to transmit file FK2 to itself, and the user node 208 request the user node 206 to transmit file FK3 to itself. Under the condition without considering the file sizes, since the playback deadline of the files FK1 is the minimum among the files FK1-FK3, the bandwidth for transmitting the file FK1 to the user node 203 should be the larger than those of the other files FK2 and FK3. However, to complete the file transmission before the playback deadline, the scheduling method provided the exemplary example of the present disclosure not only considers the playback deadlines, but also considers the file sizes.

Referring to FIG. 6 and FIG. 7, FIG. 7 is a curve diagram showing the playback deadline left versus the priority of the file according to an exemplary example of the present disclosure. In the present disclosure, the priority of the file is determined by the playback deadline. To put it concretely, the priority of the file is determined according to the time difference between a current transmission time and the playback deadline of the file, and the time difference between a current transmission time and the playback deadline of the file is called the playback deadline left in FIG. 7. In FIG. 7, the priority of the file is determined by the curve CU1 or the CU2. The curve CU1 is the quantized curve showing the relation of the playback deadline left and the priority of the file, and the curve CU2 is the mathematical curve showing the relation of the playback deadline left and the priority of the file. The relation of the playback deadline left and the priority of the file corresponding curve CU2 can be model as the equation, Y=AX^{-α}, wherein the variable Y is presented as the priority of the file, the variable X is presented as the playback deadline left of the file, and variables A and α are larger than zero and can be adjusted or set by the user or the administrator. In the exemplary example, the values of the variables A and α are respectively set as 23 and 0.97. However, the equation and variables A and α are not used to limit the present disclosure. In the exemplary example of FIG. 6 and FIG. 7, the priorities of the files FK1-Fk3 are 100, 25, and 13.

After the priorities of files shown in FIG. 6 are calculated, the bandwidth for transmitting the file is determined according to the priorities and the file sizes of the files. In other words, the bandwidth for transmitting the file is determined according to the playback deadline lefts and the file sizes of the files. Most peer-to-peer data transmission system has the asymmetric upload and download bandwidths, for example the upload and download bandwidths are respectively 2 Mbps and 10 Mbps. Therefore, a scheduling method for peer-to-peer data transmission considering the upload bandwidth is provided according to an exemplary example the present disclosure, and according to another an exemplary example the present disclosure, a scheduling method for peer-to-peer data transmission considering both of the upload and download bandwidths is provided. Furthermore, in some particular condition, the upload and download bandwidths are the same one, and thus, a scheduling method for peer-to-peer data transmission considering the download bandwidth is provided according to another exemplary example the present disclosure.

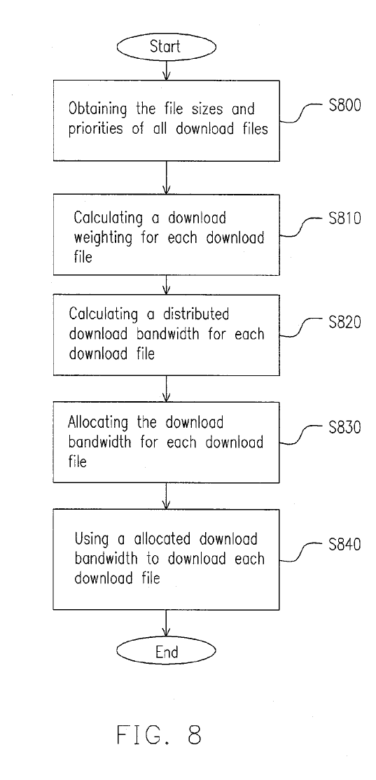

Referring to FIG. 8, FIG. 8 is a flow chart showing a scheduling method for peer-to-peer data transmission according to one exemplary example. An exemplary example of the present disclosure provides a scheduling method for peer-to-peer data transmission. The scheduling method is applied in the peer-to-peer data transmission system, wherein the peer-to-peer data transmission system comprises a plurality of user nodes, and the user nodes act as the upload nodes and the download nodes. Herein, one of the user nodes is presented as the i^{th} node, and the other one node connected to the i^{th} node is presented as the j^{th} node. In step S800, the information of the file sizes of the download files of the i^{th} node is obtained, and the priorities of the download files thereof are calculated according to a plurality of time differences between a current transmission time and a plurality of playback deadlines of multiple download files downloaded by the i^{th} node, wherein the manner how the priorities of the download files of the i^{th} node can be calculated is illustrated in FIG. 7 and the related description, and is not described again.

It is noted that the implementation of the step S800 can be executed by the i^{th} node, part of user nodes, or a central server node. That is the executing device is not used to limit the present disclosure. Regarding the steps illustrated below, they can be executed by the i^{th} node, part of user nodes, or a central server node.

Next, in step S810, a download weighting for each download file is calculated according to the priorities and the file sizes of the download files of the i^{th} node. The mathematic equation used to calculate the download weighting for each download file of the i^{th} node is not used to limit the present disclosure, and in the exemplary example, the mathematic equation is expressed as, Cⱼ=κⱼ·size(Fⱼ)/Σ_{j≠i,j∈ all peer-to-peer session}κⱼ·size(Fⱼ), wherein the download weighting for the download file downloaded from the j^{th} node to the i^{th} node is presented as Cⱼ, the file size and the priority of the download file Fⱼ downloaded from the j^{th} node to the i^{th} node are presented as size(Fⱼ) and κⱼ.

The total available download bandwidth DBW of the i^{th} node is the ideal total download bandwidth DR multiplying the a constant value μ, i.e. DBW=DR×μ, wherein the constant value μ is less than 1 and larger than 0, and can be a estimated value or a value predefined by the user. In step S820, a distributed download bandwidth Dⱼ for each download file Fⱼ of the i^{th} node is calculated according to the download weighting Cⱼ, wherein the distributed download bandwidth Dⱼ is the download weighting Cⱼ multiplying the total available download bandwidth DBW of the i^{th} node, i.e. Dⱼ=DBW×Cⱼ.

Next, in step S830, the i^{th} node is allocated the download bandwidth for each download file according to the distributed download bandwidth thereof. The simple way is to allocate the i^{th} node the distributed download bandwidth Dⱼ for the download file Fⱼ. However to prevent the some interrupting condition or fatal, the i^{th} node is allocated the distributed download bandwidth Dⱼ minus the positive protective amount for the download file Fⱼ, or the i^{th} node is allocated the minimum of the distributed download bandwidth Dⱼ and the available upload bandwidth of the j^{th} node. Finally, in step S840, the i^{th} node uses the allocated download bandwidth for the download file Fⱼ to download the download file Fⱼ from the j^{th} node.

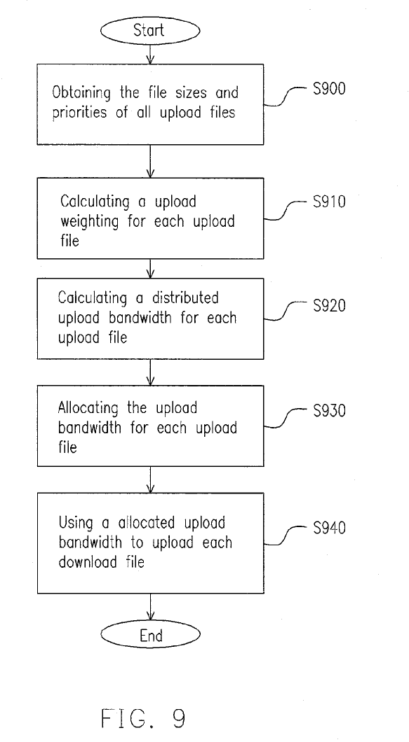

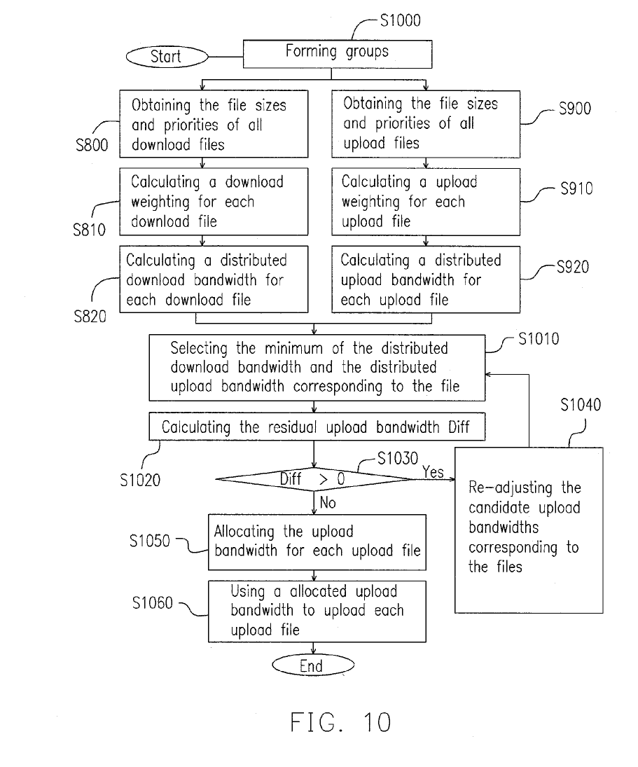

Referring to FIG. 9, FIG. 9 is a flow chart showing a scheduling method for peer-to-peer data transmission according to another one exemplary example. An exemplary example of the present disclosure provides a scheduling method for peer-to-peer data transmission. The scheduling method is applied in the peer-to-peer data transmission system, wherein the peer-to-peer data transmission system comprises a plurality of user nodes, and the user nodes act as the upload nodes and the download nodes. Herein, one of the user nodes is presented as the j^{th} node, and the other one node connected to the i^{th} node is presented as the j^{th} node. In step S900, the information of the file sizes of the upload files thereof is obtained, and the priorities of the upload files thereof are calculated according to a plurality of time differences between a current transmission time and a plurality of playback deadlines of multiple upload files upload by the j^{th} node, wherein the manner how the priorities of the upload files of the i^{th} node can be calculated is illustrated in FIG. 7 and the related description, and is not described again.

It is noted that the implementation of the step S900 can be executed by the j^{th} node, part of user nodes, or a central server node. That is the executing device is not used to limit the present disclosure. Regarding the steps illustrated below, they can be executed by the j^{th} node, part of user nodes, or a central server node.

Next, in step S910, an upload weighting for each upload file is calculated according to the priorities and the file sizes of the download files of the j^{th} node. The mathematic equation used to calculate the upload weighting for each upload file of the j^{th} node is not used to limit the present disclosure, and in the exemplary example, the mathematic equation is expressed as, Cᵢ=κᵢ·size(Fᵢ)/Σ_{i≠j,i∈ all peer-to-peer session}κᵢ·size(Fᵢ), wherein the download weighting for the download file uploaded from the j^{th} node to the i^{th} node is presented as Cᵢ, the file size and the priority of the download file Fᵢ uploaded from the j^{th} node to the i^{th} node are presented as size(Fᵢ) and κᵢ.

The total available upload bandwidth UBW of the j^{th} node is the ideal total upload bandwidth UR multiplying the a constant value μ, i.e. UBW=UR×μ, wherein the constant value μ is less than 1 and larger than 0, and can be a estimated value or a value predefined by the user. In step S920, a distributed upload bandwidth Uᵢ for each upload file Fᵢ of the j^{th} node is calculated according to the upload weighting Cᵢ, wherein the distributed upload bandwidth Uᵢ is the upload weighting Cᵢ multiplying the total available upload bandwidth UBW of the j^{th} node, i.e. Uᵢ=UBW×Cᵢ.

Next, in step S930, the j^{th} node is allocated the upload bandwidth for each upload file according to the distributed upload bandwidth thereof. The simple way is to allocate the j^{th} node the distributed upload bandwidth Uᵢ for the upload file Fᵢ. However to prevent the some interrupting condition or fatal, the j^{th} node is allocated the distributed upload bandwidth Uⱼ minus the positive protective amount for the upload file Fᵢ, or the j^{th} node is allocated the minimum of the distributed upload bandwidth Uᵢ and the available download bandwidth of the i^{th} node. Finally, in step S940, the j^{th} node uses the allocated upload bandwidth for the upload file Fᵢ to upload the upload file Fᵢ to the i^{th} node.

Referring to FIG. 10, FIG. 10 is a flow chart showing a scheduling method for peer-to-peer data transmission according to another one exemplary example. An exemplary example of the present disclosure provides a scheduling method for peer-to-peer data transmission. The scheduling method is applied in the peer-to-peer data transmission system, wherein the peer-to-peer data transmission system comprises a plurality of user nodes, and the user nodes act as the upload nodes and the download nodes. Herein, one of the user nodes is presented as the i^{th} node, and the other one node connected to the i^{th} node is presented as the j^{th} node. The steps S800-S820 in FIG. 10 are the same as those in FIG. 8, and the steps S900-S920 in FIG. 9 are the same as those in FIG. 9. Thus the steps S800-820 and S900-920 in FIG. 10 are not described again. However, the variables used in FIG. 8 and FIG. 9 are modified, wherein the variable Fᵢⱼ presents the download file downloaded from the j^{th} node to the i^{th} node, or the upload file uploaded from the j^{th} node to the i^{th} node, the variable Uᵢⱼ presents the distributed upload bandwidth of the upload file uploaded from the j^{th} node to the i^{th} node, and the variable Dᵢⱼ presents the distributed download bandwidth of the download file downloaded from the j^{th} node to the i^{th} node.

At step S1000, a plurality of user nodes are divided into several groups according to the condition which the file segments owned by the user nodes, wherein the user nodes in the same group have the at least one of the identical file segments. In addition, the manner for dividing the user nodes into several groups can be the manner as illustrated above, and therefore omitting the related description. It is noted that, implementation of each of the steps in FIG. 10 are illustrated above, which can be executed by the program of one of the nodes, or by the incorporated program by the partial of the nodes, or by the program of the central server.

In step S1010, the minimum of the distributed download bandwidth Dᵢⱼ and the distributed upload bandwidth Uᵢⱼ is selected as a candidate upload bandwidth U′ᵢⱼ of the j^{th} node for the upload file Fᵢⱼ. In step S1020, the residual upload bandwidth Diff of each node is calculated, wherein the residual upload bandwidth Diff of the j^{th} node is the total available upload bandwidth of the j^{th} node minus the summation the candidate upload bandwidths of the j^{th} node. Next, in step S1020, whether the residual upload bandwidth Diff of the j^{th} node is larger than zero is checked. If the residual upload bandwidth Diff of the j^{th} node is larger than zero, the step S1040 is executed; otherwise, the step S1050 is executed.

In step 1040, the candidate upload bandwidths corresponding to the files uploaded by the j^{th} node are re-adjusted, and the set each of re-adjusted candidate upload bandwidths as the corresponding distributed upload bandwidth, wherein each of the candidate upload bandwidths is the original candidate upload bandwidth plus a positive delta amount, and the summation of the re-adjusted candidate upload bandwidths at most equals to the total upload bandwidth which the j^{th} node can use. In step S1050, the j^{th} node is allocated the upload bandwidth for each upload file according to the candidate upload bandwidth thereof. The simple way is to allocate the j^{th} node the candidate upload bandwidth Uᵢ as the upload bandwidth for uploading the file Fᵢ. Finally, in step S940, the j^{th} node uses the allocated upload bandwidth (i.e. the upload bandwidth of the upload file Fᵢ determined at step S1050) for the upload file Fᵢ to upload the upload file Fᵢ to the i^{th} node.

Referring to FIG. 2 and FIG. 10, the user nodes 203, 204, 208 are connected to the user node 206, and the available download bandwidth of the user nodes 203, 204, and 208 corresponding to the user node 206 are 350, 90, and 500 Kilo-bits per second (Kbps). Assuming that the total available upload bandwidth of the user node 206 is 500 Kbps, and playback deadlines of the files requested by the user nodes 203, 204, and 208 are respectively 09:45:00, 10:15:00, and 10:45:00, and file sizes of the files requested by the user nodes 203, 204, and 208 are respectively 10 MBs, 20 MBs, and 100 MBs, therefore the priorities of the files requested by the user nodes 203, 204, and 208 are respectively 100, 25, and 13, and in step S1010 the candidate upload bandwidths of the user node 206 of the files requested by the user nodes 203, 204, 208 are respectively 180, 90, 220 Kbps. In step 1030, the residual upload bandwidth Diff is larger than 0, and therefore the steps 1040 is executed. At step S1040, the candidate upload bandwidths of the user node 206 of the files requested by the user nodes 203, 204, 208 are re-adjusted respectively to 183, 90, and 227 Kbps, and set the re-adjusted candidate upload bandwidths as the distributed upload bandwidths. Finally, at step S1060, the user node 206 use the upload bandwidths of 183, 90, 227 Kbps to upload the upload files to the user nodes 203, 204, and 208. Therefore, the method provided by FIG. 10 can let each of the user nodes efficiently use the total available upload bandwidth, without causing bandwidth waste.

Accordingly, the scheduling method for peer-to-peer data transmission, the node and system using the scheduling method of the present disclosure are illustrated above. The scheduling method for peer-to-peer data transmission improves the problem of the congestion in the network, makes the nodes efficiently share the files, and avoids the case that the node obtains the file after the playback deadline of the file. That is, the scheduling method for peer-to-peer data transmission try to guarantees the nodes obtains the file before the playback deadline of the file. Furthermore, in one exemplary example, a re-adjusting mechanism is used to efficiently utilize the total available upload bandwidth of the user node.

It will be apparent to those skilled in the art that various modifications and variations can be made to the structure of the present disclosure without departing from the scope or spirit of the present disclosure. In view of the foregoing descriptions, it is intended that the present disclosure covers modifications and variations of the present disclosure if they fall within the scope of the following claims and their equivalents.

What is claimed is:

1. A scheduling method for peer-to-peer data transmission, used in a peer-to-peer system, the peer-to-peer system comprises a plurality of nodes, the nodes comprises an i^{th} node and a j^{th} node, wherein the j^{th} node uploads a plurality of upload files to the nodes connected thereto, and the upload files comprises an upload file Fᵢⱼ uploaded to the i^{th} node, and the scheduling method comprising:
determining a distributed upload bandwidth Uᵢⱼ of the upload file Fᵢⱼ according to at least one of time differences between a current transmission time and at least one of playback deadlines of the upload files and at least one of file sizes of the upload files.

2. The scheduling method recited as claim 1, wherein the step of determining the distributed upload bandwidth Uᵢⱼ of the upload file Fᵢⱼ further comprising:
determining an upload weight of the upload file Fᵢⱼ according to the at least one of time differences between a current transmission time and at least one of playback deadlines of the upload files and the at least one of file sizes of the upload files; and
determining the distributed upload bandwidth Uᵢⱼ of the upload file Fᵢⱼ according to the upload weight.

3. The scheduling method recited as claim 1, wherein the distributed upload bandwidth Uᵢⱼ is determined according to all of the time differences and all of the file sizes.

4. The scheduling method recited as claim 3, wherein the step of determining the distributed upload bandwidth Uᵢⱼ of the upload file Fᵢⱼ further comprising:
determining a plurality of priorities of the upload files according to the time differences;
determining an upload weight of the upload file Fᵢⱼ according to the priorities and the file sizes; and
determining the distributed upload bandwidth Uᵢⱼ of the upload file Fᵢⱼ according to the upload weight.

5. The scheduling method recited as claim 1, further comprising:
determining an upload bandwidth for uploading the upload file Fᵢⱼ from the j^{th} node to the i^{th} node according to the distributed upload bandwidth Uᵢⱼ.

6. The scheduling method recited as claim 5, wherein the upload bandwidth for uploading the upload file Fᵢⱼ from the j^{th} node to the i^{th} node is equal to the distributed upload bandwidth Uᵢⱼ.

7. The scheduling method recited as claim 5, wherein the upload bandwidth for uploading the upload file Fᵢⱼ from the j^{th} node to the i^{th} node is equal to the distributed upload bandwidth Uᵢⱼ minus a positive protective mount.

8. The scheduling method recited as claim 5, wherein the upload bandwidth for uploading the upload file Fᵢⱼ from the j^{th} node to the i^{th} node is a minimum of the distributed upload bandwidth Uᵢⱼ and an available download bandwidth of the i^{th} node.

9. A scheduling method for peer-to-peer data transmission, used in a peer-to-peer system, the peer-to-peer system comprises a plurality of nodes, the nodes comprises an i^{th} node and a j^{th} node, wherein the i^{th} node downloads a plurality of download files to the nodes connected thereto, and the download files comprises an download file Fᵢⱼ downloaded from the j^{th} node, and the scheduling method comprising:
determining a distributed download bandwidth Dᵢⱼ of the download file Fᵢⱼ according to at least one of time differences between a current transmission time and at least one of playback deadlines of the download files and at least one of file sizes of the download files.

10. The scheduling method recited as claim 9, wherein the step of determining the distributed download bandwidth Dᵢⱼ of the download file Fᵢⱼ further comprising:
determining a download weight of the download file Fᵢⱼ according to the at least one of time differences between a current transmission time and at least one of playback deadlines of the download files and the at least one of file sizes of the download files; and
determining the distributed download bandwidth Dᵢⱼ of the download file Fᵢⱼ according to the download weight.

11. The scheduling method recited as claim 9, wherein the distributed download bandwidth Dᵢⱼ is determined according to all of the time differences and all of the file sizes.

12. The scheduling method recited as claim 11, wherein the step of determining the distributed download bandwidth Dᵢⱼ of the download file Fᵢⱼ further comprising:
determining a plurality of priorities of the download files according to the time differences;
determining a download weight of the download file Fᵢⱼ according to the priorities and the file sizes; and
determining the distributed download bandwidth Dᵢⱼ of the download file Fᵢⱼ according to the download weight.

13. The scheduling method recited as claim 9, further comprising:
determining a download bandwidth for downloading the download file Fᵢⱼ from the j^{th} node to the i^{th} node according to the distributed download bandwidth Dᵢⱼ.

14. The scheduling method recited as claim 13, wherein the download bandwidth for downloading the download file Fᵢⱼ from the j^{th} node to the i^{th} node is equal to the distributed download bandwidth Dᵢⱼ.

15. The scheduling method recited as claim 13, wherein the download bandwidth for downloading the download file Fᵢⱼ from the j^{th} node to the i^{th} node is equal to the distributed download bandwidth Dᵢⱼ minus a positive protective mount.

16. The scheduling method recited as claim 13, wherein the download bandwidth for downloading the download file Fᵢⱼ from the j^{th} node to the i^{th} node is a minimum of the distributed download bandwidth Uᵢⱼ and an available upload bandwidth of the j^{th} node.

17. A scheduling method for peer-to-peer data transmission, used in a peer-to-peer system, the peer-to-peer system comprises a plurality of nodes, the nodes comprises an i^{th} node and a j^{th} node, wherein the j^{th} node uploads a plurality of upload files to the nodes connected thereto, the i^{th} node downloads a plurality of download files to the nodes connected thereto, the upload files comprises an upload file Fᵢⱼ uploaded to the i^{th} node, the download files comprises an download file Fᵢⱼ downloaded from the j^{th} node, the upload file Fᵢⱼ is the download file Fᵢⱼ, and the scheduling method comprising:
determining a distributed upload bandwidth Uᵢⱼ of the upload file Fᵢⱼ according to at least one of time differences between a current transmission time and at least one of playback deadlines of the upload files and at least one of file sizes of the upload files;
determining a distributed download bandwidth Dᵢⱼ of the download file Fᵢⱼ according to at least one of time differences between a current transmission time and at least one of playback deadlines of the download files and at least one of file sizes of the download files; and
allocating an upload bandwidth for uploading the upload file Fᵢⱼ from the j^{th} node to the i^{th} node according to a minimum of the distributed upload bandwidth Uᵢⱼ of the upload file Fᵢⱼ and the distributed upload bandwidth Uᵢⱼ of the upload file Fᵢⱼ.

18. The scheduling method recited as claim 17, wherein the step of determining the distributed upload bandwidth Uᵢⱼ of the upload file Fᵢⱼ further comprising:
determining an upload weight of the upload file Fᵢⱼ according to the at least one of time differences between a current transmission time and at least one of playback deadlines of the upload files and the at least one of file sizes of the upload files; and
determining the distributed upload bandwidth Uᵢⱼ of the upload file Fᵢⱼ according to the upload weight;
and wherein the step of determining the distributed download bandwidth Dᵢⱼ of the download file Fᵢⱼ further comprising:
determining a download weight of the download file Fᵢⱼ according to the at least one of time differences between a current transmission time and at least one of playback deadlines of the download files and the at least one of file sizes of the download files; and
determining the distributed download bandwidth Dᵢⱼ of the download file Fᵢⱼ according to the download weight.

19. The scheduling method recited as claim 17, wherein the distributed upload bandwidth Uᵢⱼ is determined according to all of the time differences and all of the file sizes, and the distributed download bandwidth Dᵢⱼ is determined according to all of the time differences and all of the file sizes.

20. The scheduling method recited as claim 19, wherein the step of determining the distributed upload bandwidth Uᵢⱼ of the upload file Fᵢⱼ further comprising:
determining a plurality of priorities of the upload files according to the time differences;
determining an upload weight of the upload file Fᵢⱼ according to the priorities and the file sizes; and
determining the distributed upload bandwidth Uᵢⱼ of the upload file Fᵢⱼ according to the upload weight;
and wherein the step of determining the distributed download bandwidth Dᵢⱼ of the download file Fᵢⱼ further comprising:
determining a plurality of priorities of the download files according to the time differences;
determining a download weight of the download file Fᵢⱼ according to the priorities and the file sizes; and
determining the distributed download bandwidth Dᵢⱼ of the download file Fᵢⱼ according to the download weight.

21. The scheduling method recited as claim 17, wherein the step of allocating the upload bandwidth for uploading the upload file Fᵢⱼ from the j^{th} node to the i^{th} node comprising:
selecting the minimum of the distributed upload bandwidth Uᵢⱼ of the upload file Fᵢⱼ and the distributed upload bandwidth Uᵢⱼ of the upload file Fᵢⱼ as a candidate upload bandwidth of the upload file Fᵢⱼ;
calculating a residual upload bandwidth according the candidate upload bandwidths of the upload files;
determining whether the residual upload bandwidth is larger than 0;
if the residual upload bandwidth is larger than 0, re-adjusting the candidate upload bandwidths of the upload files;
if the residual upload bandwidth is not larger than 0, allocating the upload bandwidth for uploading the upload file Fᵢⱼ from the j^{th} node to the i^{th} node according to the candidate upload bandwidth of the upload file Fᵢⱼ.

22. An upload node for peer-to-peer data transmission, used in a peer-to-peer system, the peer-to-peer system comprises a plurality of nodes, the nodes comprises an i^{th} node, wherein the upload node uploads a plurality of upload files to the nodes connected thereto, and the upload files comprises an upload file Fᵢ uploaded to the i^{th} node, and upload node is characterized in:
the upload node determines a distributed upload bandwidth Uᵢ of the upload file Fᵢ according to at least one of time differences between a current transmission time and at least one of playback deadlines of the upload files and at least one of file sizes of the upload files.

23. A download node for peer-to-peer data transmission, used in a peer-to-peer system, the peer-to-peer system comprises a plurality of nodes, the nodes comprises a j^{th} node, wherein the download node downloads a plurality of download files to the nodes connected thereto, and the download files comprises an download file Fⱼ downloaded from the j^{th} node, and the download node is characterized in:
the download node determines a distributed download bandwidth Dⱼ of the download file Fⱼ according to at least one of time differences between a current transmission time and at least one of playback deadlines of the download files and at least one of file sizes of the download files.

24. A peer-to-peer system, the peer-to-peer system comprises a plurality of nodes, the nodes comprises an i^{th} node and a j^{th} node, wherein the j^{th} node uploads a plurality of upload files to the nodes connected thereto, the i^{th} node downloads a plurality of download files to the nodes connected thereto, the upload files comprises an upload file Fᵢⱼ uploaded to the i^{th} node, the download files comprises an download file Fᵢⱼ downloaded from the j^{th} node, the upload file Fᵢⱼ is the download file Fᵢⱼ, and the peer-to-peer system is characterized in:
a distributed upload bandwidth Uᵢⱼ of the upload file Fᵢⱼ is determined according to at least one of time differences between a current transmission time and at least one of playback deadlines of the upload files and at least one of file sizes of the upload files;
a distributed download bandwidth Dᵢⱼ of the download file Fᵢⱼ is determined according to at least one of time differences between a current transmission time and at least one of playback deadlines of the download files and at least one of file sizes of the download files; and
an upload bandwidth for uploading the upload file Fᵢⱼ from the j^{th} node to the i^{th} node is allocated according to a minimum of the distributed upload bandwidth Uᵢⱼ of the upload file Fᵢⱼ and the distributed upload bandwidth Uᵢⱼ of the upload file Fᵢⱼ.
